(19) United States
(12) Patent Application Publication
(10) Pub. No.: US 2017/0262825 A1
(43) Pub. Date: Sep. 14, 2017

(54) LICENSE RECOMMENDATION SERVICE

(71) Applicant: Microsoft Technology Licensing, LLC, Redmond, WA (US)

(72) Inventors: Ashleigh Patricia Conway, Dublin (IE); Darren Doyle, Dublin (IE); David Mowatt, Dublin (IE); Pieter Kasselman, Dublin (IE); Terry Farrell, Dublin (IE)

(21) Appl. No.: 15/068,480

(22) Filed: Mar. 11, 2016

(51) Int. Cl. G06Q 20/12; G06F 21/10; G06Q 30/06

(52) U.S. Cl. CPC G06Q 20/1235; G06Q 30/0631; G06Q 30/0641; G06F 21/105

(57) ABSTRACT

A license recommendation service in an online app store is disclosed herein. The license recommendation service collects usage information related to the actual usage of an application (or applications) downloaded from the app store. The actual usage pertains to how a user uses an application under an initial license. A license recommendation may be made based on the actual usage of the application. The service communicates to the local execution environment in which the application executes such that the recommendation may be surfaced in the context of the user moving to a subsequent license.

### TECHNICAL BACKGROUND

Online application stores (or “app stores”) have become a dominant way for digital content to be distributed. In the app store model, developers upload their applications or other such content to an app store. End users connect to the app store through an interface on their local computing devices, through which they may browse the collections made available in the app stores. Once a user selects an application, the application is downloaded and installed in a local execution environment. Examples include the App Store® for iOS® devices, the Google Play™ for Android™ devices, and the Windows® App Store.

Many applications are offered under a variety of different licenses that a user must consider when browsing in an app store. For example, an application may be offered under a home license, an enterprise license, or a subscription license. A user may obtain an application under one license and then, based on trial and error, return to the app store at a later time to upgrade or otherwise change to a different license. Some applications allow for a trial period during which a user may “preview” an application without having to commit to a specific license, but the user must eventually obtain a regular license to the app.

In the background, developers strive to offer license terms that are attractive to end users, yet that satisfy the business goals of the developer. This may involve the developer employing systems and services to discover how customers use their applications in order to optimize their license offerings. From a more technical perspective, such systems are difficult to deploy and maintain, and are a waste of resources when duplicated across multiple developers and applications.

### OVERVIEW

A license recommendation service in an online app store is disclosed herein. The license recommendation service collects usage information related to the actual usage of an application (or applications) downloaded from the app store. The actual usage pertains to how a user uses an application under an initial license. The service identifies a subsequent license that may be well suited to the actual usage of the application and communicates a recommendation to the local execution environment in which the application executes. The recommendation may be surfaced in the context of the user moving to a subsequent license and wanting to review the available license options.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment in an implementation of license recommendation technology.

FIG. 2 illustrates a recommendation process in an implementation.

FIG. 3 illustrates an operational environment in an implementation of license recommendation technology.

FIG. 4 illustrates a recommendation process in an implementation.

FIG. 5 illustrates an operational sequence in an implementation of license recommendation technology.

FIG. 6 illustrates a recommendation process in an implementation.

FIG. 7 illustrates a computing system suitable for implementing the licensing recommendation technology disclosed herein, including any of the architectures, elements, processes, and operational scenarios and sequences illustrated in the Figures and discussed below in the Technical Disclosure.

### TECHNICAL DISCLOSURE

License recommendation technology disclosed herein enhances the application licensing process in online application stores. In an implementation, developers may integrate an API into their applications that allow an app to report its actual usage to the online app store. The app store may then guide transaction decisions by recommending an optimal license for a given user-based on his or her actual usage of an application. In some implementations, the actual usage may relate to how a user used an app during a trial period. In other implementations, the actual usage may have been under a regular license from which the user wishes to depart (upgrade, downgrade, etc.

Such technology removes the burden of monitoring user behavior from application developers/vendors. From a more technical perspective, the technology removes the need duplicative systems across developers and vendors, which conserves computing and communication resources.

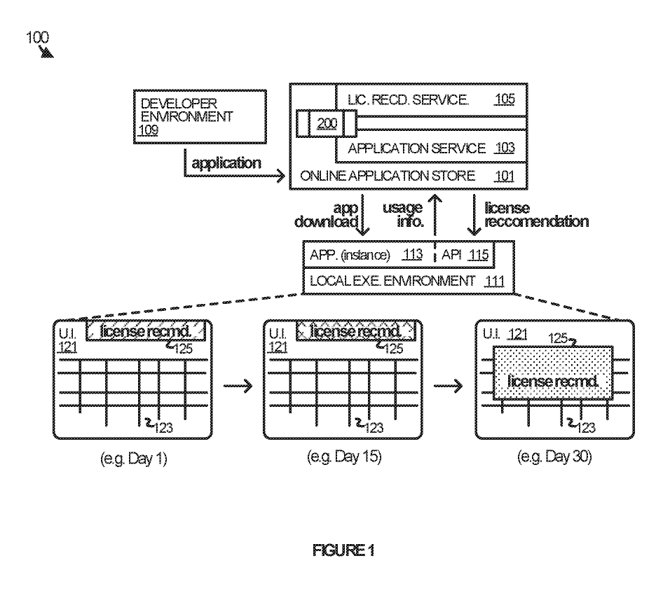

FIG. 1 illustrates operational environment 100 in an implementation of enhanced licensing technology. Operational environment 100 includes online application store 101, a developer environment 109, and a local execution environment. Online application store 101 includes an application service 103 and a license recommendation service 105. Local execution environment 111 includes an instance of an application downloaded from online application store 101, represented by application 113. Application 113 includes an application programming interface, API 115, for interfacing with license recommendation service 105.

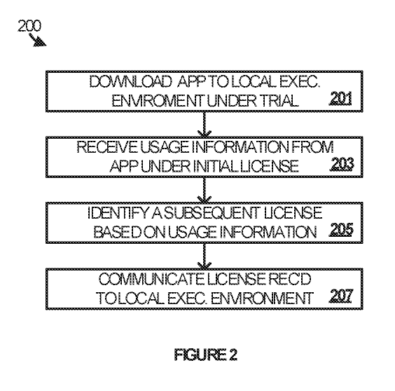

Online application store 101 employs recommendation process 200 to make license recommendations. The following makes parenthetical reference to the steps illustrated in FIG. 2 with respect to recommendation process 200.

In operation, applications are developed and uploaded to online application store 101 for digital distribution to local execution environments. The applications may be developed in any suitable system or platform, of which development environment 109 is representative. The apps may be provided to online application store 101 by multiple vendors such that online application store 101 may serve as a central point for users to browse and purchase application licenses.

A user may browser the app store through a dedicated app store application on their computing device, through a web browser, or via some other suitable mechanism. An application service, of which application service 103 is representative, hosts a store-front interface and handles various aspects of the browsing and transaction experience.

Once an application is selected, it is downloaded from application service 103 to a computing device and installed in a local execution environment (step 201). In this example, application 113 is downloaded and installed in local execution environment 111. The application 113 is installed under an initial license. The initial license may be, for example, for a preview or trial period of usage. In another example, the initial license may be a regular, non-trial/non-preview license selected by a user.

As the user engages with and utilizes application 113, API 115 reports the actual usage of the application, which is received by license recommendation service 105 (step 203). License recommendation service 105 processes the usage information to identify a subsequent license to recommend to the user (step 205). To do so, license recommendation service 105 may compare the actual usage to criteria provided by the developer of the application that defines which available license is a best fit for a given usage profile.

Optionally, the actual usage may be compared against the actual usage by other users of other instances of the application under one or more of the available licenses. The actual usage of the targeted user may be mapped to one of several usage profiles developed from the usage of the other users. License recommendation service 105 may then infer that the best license (and the one to recommend) is the one associated with the usage profile that is the best fit to the actual usage. In other words, each of the available licenses may correspond to one of several usage profiles developed from the observed usage of other users. The target user's actual usage may then be mapped to a given license based on which of the several usage profiles is a best fit to the actual usage.

Machine learning may be employed by license recommendation service 105 to map the usage profiles of the other users to the available licenses, as well as to continuously update the mappings. This may have the added technical effect of removing the need for the developer(s) to create and provide the mappings. Rather, license recommendation service 105 can discover over time which licenses fit which usage profiles (based on observed usage of an application by various users under various licenses).

The subsequent license may be, for example, a specific one of a variety of regular licenses available for the application. The license recommendation service 105 then communicates a license recommendation to the local execution environment 111 (step 207). The recommendation identifies the subsequent license such that it may be surfaced in a user interface to application 113, a user interface to online application store 101, or some other interface.

As an example, application 113 may render user interface 121 through which content 123 and other application content may be displayed (e.g. a spreadsheet). The license recommendation provided by license recommendation service 105 may be communicated and displayed in the context of a message 125 that application 113 presents in user interface 121.

In some implementations, the message 125 may include text, video, or images, or other such content that is descriptive of the recommended license. Message 125 may change over time and depending upon how a user has interacted with previous messages. As a brief example in FIG. 1, message 125 changes in appearance and/or content over time. At day 1 of a trial period (or any other period during which a license recommendation may be formulated), message 125 appears one way. At day 15 its appearance/content changes, and at day 30 it changes even more. License recommendation service 105 may select the characteristics of message 125 and may control when at how it changes. Alternatively, application 125 control how message 125 is presented in user interface 121.

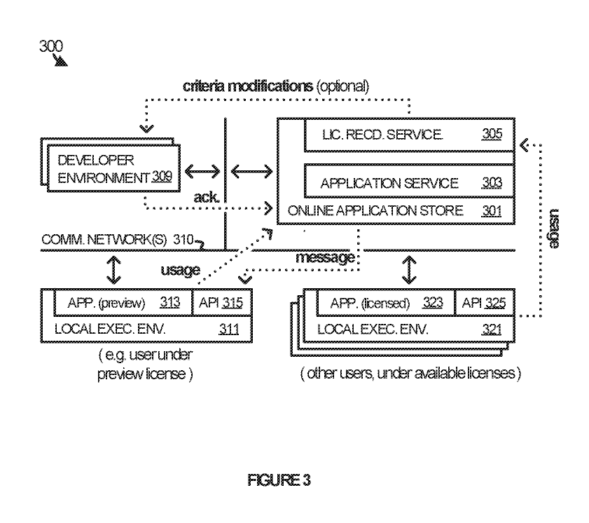

FIG. 3 illustrates operational environment 300 in another implementation of license recommendation technology. Operational environment 300 includes online application store 301, developer environment 309, local execution environment 311 and location execution environment 321, and communication network 310. Online application store 301 also includes application service 303 and license recommendation service 305.

Local execution environment 311 includes application 313, while local execution environment 321 includes application 323. Application 313 is representative of a single instance of an application that is licensed on a preview/trial basis. Application 323 is representative of an installed base of applications licensed under a regular (non-trial) license. Application 311 and application 323 include API 315 and API 325 respectively. API 315 and API 325 provide an interface between applications 311 and 323 and license recommendation service 305.

In general, application 323 (and other applications like it) reports its actual usage to via. API 325 to license recommendation service 305. License recommendation service 305 analyzes the usage data points using machine teaming in order to develop usage profiles for the available license for the application. Application 313 may also report its actual usage to license recommendation service 305 via API 315. License recommendation service 305 replies with a license recommendation message that may include text, images, video and/or other content indicative of a recommended license. In some implementations, license recommendation service 305 may optionally suggest modifications to criteria provided by developers, who may provide acknowledgements in reply.

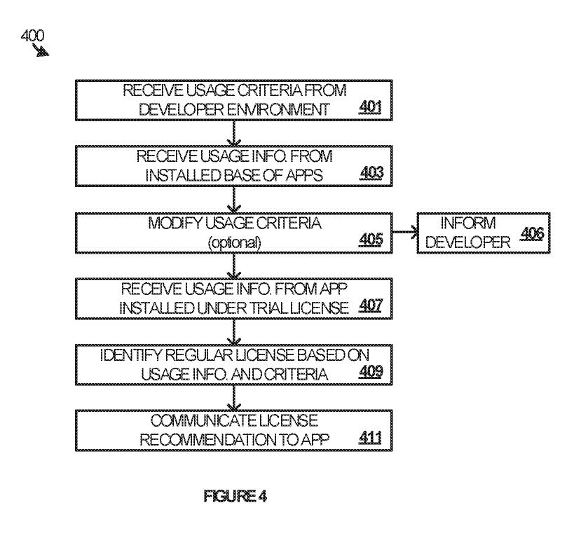

Online application store 301 employs recommendation process 400 to make license recommendations to customers of the app store. The following makes parenthetical reference to the steps illustrated in FIG. 4 with respect to recommendation process 400.

In operation, applications are developed and uploaded to online application store 301 for digital distribution to local execution environments. The apps may be uploaded to online application store 301 by multiple vendors from suitable developer environments, of which developer environment 309 is representative. The developers also provide usage criteria for each application that is received by online application store (step 401). The applications may then be downloaded by customers to their local execution environments.

Application service 303 hosts a store-front interface through which users may browse the applications provided through the app store. A web browser, dedicated app, or some other solution may be employed on the end user's device to facilitate such an experience. Once an application is selected, it is downloaded from application service 303 to a computing device and installed in a local execution environment.

The usage criteria defines the various licenses that may be available for each application and the types of use that may be appropriate for each license. For example, an application may be offered under a home license, an enterprise license, and a subscription license, or any combination thereof. Usage criteria, for the application may indicate that an individual license is appropriate for users intending to utilize the application alone, whereas the usage criteria may suggest an expanded license for users intending to share the application with other people (e.g. identified via distinct computer logins). In another example, the usage criteria may suggest a home license for home users and an enterprise license for business users. In yet another example, a one-time license may be suggested for some usage patterns, while a subscription license may be suggested for others. Numerous other license suggestions, usage patterns, and the like may be suggested in the usage criteria and may be considered within the scope of the present disclosure.

License recommendation service 305 receives actual usage information from the installed base of applications represented by application 323 (step 403). The applications report their actual usage under their various licenses through the API present in each application.

In some cases, license recommendation service may optionally modify the usage criteria provided by developer environment 309 (step 405). For instance, license recommendation service 305 may ascertain from the actual usage information provided by the installed base of applications the usage pattern that best fits each type of license. If the patterns differ from those expressed in the usage criteria as specified by the developer, modifications to the criteria to align them with the observed patterns, in such a case, license recommendation service 305 could inform the developer by way of an automated feedback channel between the service and developer environment 309 (step 406). Other mechanisms for providing feedback and receiving approval for the modifications are possible are may be considered within the scope of the present disclosure.

API 315 monitors and reports on the actual usage of application 313 while in the trial mode. License recommendation service 305 receives the actual usage information (step 407) and proceeds to identify a regular license to recommend based on the actual usage information of application 313, the actual usage of others users, and the usage criteria supplied by the developer (and/or as modified by the service) (step 409). License recommendation service 325 may then communicate the recommended license to local execution environment 311.

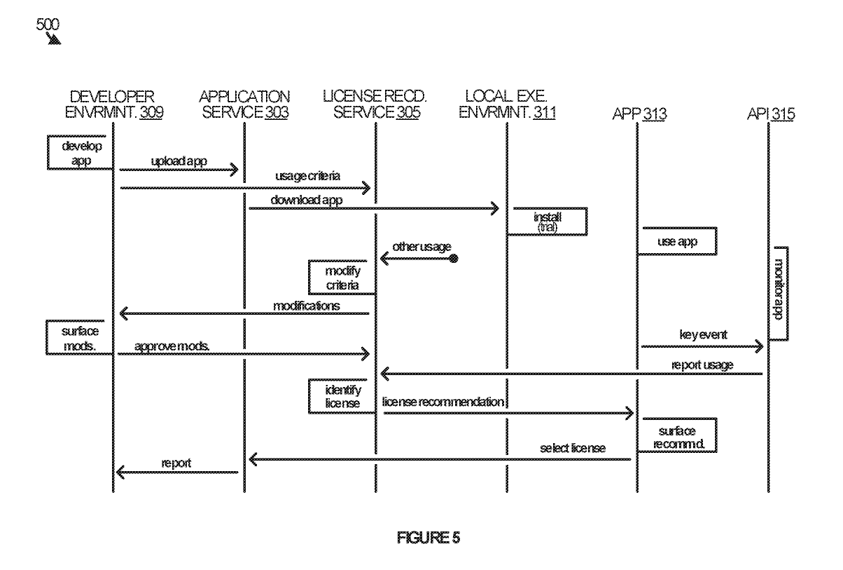

FIG. 5 illustrates an operational sequence 500 to explain further various aspects of license recommendation technology. Operational sequence 500 relates to the elements of operational environment 300 and their interaction.

In operation, an entity produces an application in a developer environment 309 and uploads the app to application service 303 to be distributed to users through an app store interface. Usage criteria accompanies the app and is stored in license recommendation service 305. The usage criteria is used to evaluate the best-fit license for a given user based on his or her actual usage of an app.

As an example, the application is downloaded from application service 303 to local execution environment 311 and is installed on a trial basis. The user beings to interact with the application 313 and its usage is monitored by API 315. In particular, API 315 monitors for various key events that trigger when to report usage information to license recommendation service 305. For example, API 315 may report usage when a particular element in a user interface is encountered by a user. Alternatively, API 315 may track usage and report periodically, regardless of how the user uses the application.

In the interim, other usage information related to the actual usage of other instances of the application is reported to license recommendation service 305. License recommendation may modify the usage criteria supplied by developer environment 309 in view of the actual usage information supplied by the other instances of the app. When modifications are warranted, license recommendation service 305 may request approval from developer environment 309 via an API back to the developer. Personnel at the developer can review the suggested modifications and reply with approval (or disapproval).

A key event eventually occurs in application 313 that triggers API 315 to report the actual usage of the application to license recommendation service 305. In response to the report, license recommendation service 305 identities a regular, non-trial license to recommend to the user. License recommendation service 305 communicates the recommendation to application 313 for application 313 to surface in its user interface. The recommendation may be communicated to a different application in place of or in addition to application 313, such as an app store app on the user's device or a web page.

Assuming the user selects the recommended license, application 313 communicates the selection to application service 303. Application service 303 updates its record for the user and the application and reports the transaction to developer environment 309. It may be understood that a different application may take the place of application 313 in this part of the sequence, such as an app store app or a web page.

It may be appreciated that, in some implementations, that license recommendation service 305 could support other application stores, in addition to online application store 301. For example, it may be assumed for exemplary purposes that online application store 301 supports applications for Windows® devices. The developers of said applications may also develop the applications for other platforms and may sell the same applications through one or more other app stores (e.g. through Play® and iTunes®). The other app stores could communicate with license recommendation service 305 to obtain license recommendations for a given user attempting to update, upgrade, or otherwise obtain a new license to an application.

In addition, the applications developed for the other platforms could include an API allowing the applications to report usage information to license recommendation service 305. Thus, license recommendation service 305 can take into account all of the usage of a particular application by a wide variety of users and on a wide variety of platforms. An application product thus be developed for multiple platforms. Usage information for the application across multiple platforms can be collected by license recommendation service 305 and taken into account when generating license recommendations across all platforms. In some scenarios, the license recommendations may be presented differently over time, so as to increase the likelihood that a user eventually interacts with a recommendation.

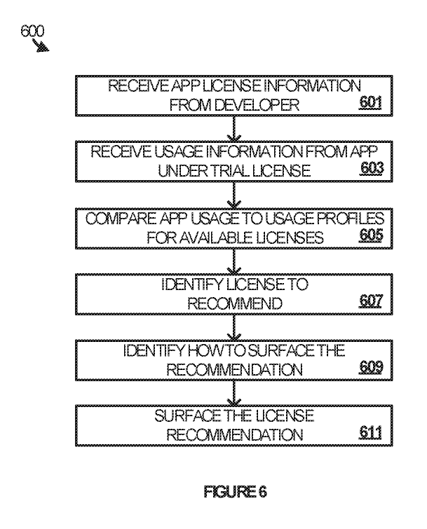

In some implementations, license recommendation service 305 may employ recommendation process 600 in FIG. 6 to make license recommendations to customers of the app store. The following makes parenthetical reference to the steps illustrated in FIG. 6 with respect to recommendation process 600.

In operation, a developer may upload an application to online application store 301 to be distributed to end-users associated with the store. In addition to the developer may provide license information associated with the application that specifies the various licenses available for the application and possibly other details (e.g. price, feature descriptions, etc.). Thus, license recommendation service 305 receives the license information (step 601). The developer may provide the license information through a portal to license recommendation service 305 when uploading the app, for example.

For instance, the developer may specify two or more licensing options via a submission portal experience, L1 and L2. The application under L1 may have twenty features, while the application under L2 may have forty features. The price point of L1 and L2 may be the same or may be different. Each license option may also have a label that describes it in basic terms, such as “basic” and “premium.” A trial period may also be specified in the information, such as fifteen or thirty days. In some cases, the developer may specify multiple price points for each license. The developer may also be able to specify custom messages for each license option.

Users may download instances of the application for user during a limited period of time under a trial license, a preview, and the like. By the end of the initial period, the developer generally wishes to convert the user to a regular, non-trial license.

To facilitate the transition from the trial license to a regular license, the application tracks the usage of the application and reports the usage to license recommendation service 305. The usage may be descriptive of what features the user uses, how often the user uses the application, whether or not the user shares the application, or any other type of user that may be tracked and reported by the application. License recommendation service 305 receives the usage information (step 603) and proceeds to compare it to usage profiles for the other licenses available for the application (step 605). A license recommendation is determined from the comparison (step 607).

Using the example of L1 and L2 above, the user's usage may be compared to the usage of other users who are licensed under L1 and to that of other users who are licensed under L2. If the usage fits that of the other users under L1 better than under L2, then L1 is chosen for the recommendation. If the usage fits that of the other users under L2 better than L1, then L2 is chosen for the recommendation.

In some cases, the use of a specific feature in an application may be determinative of which license to recommend. For instance, the developer may indicate that the use of features A and B is generally indicative of a preference for L1, whereas the user of features C and D is generally indicative of a preference for L2. The usage information reported by the application to license recommendation service 305 could thus include mention of which specific features are used by the user. If features A and B are used, then L1 may be recommended, whereas if features C and D are used, then L2 may be recommended. Such a correlation may be especially helpful if an application is relatively new and enough other users haven't been sampled yet to arrive at recommendations from their usage.

In some implementations, the price of a particular license option may vary. License recommendation system 305 may vary the price of a license that is being recommend based on a past purchase history of the user and the purchase history of other users, for example. An option may be available to the developer to specify in the license information whether or not to optimize revenue. If the option is enabled, then license recommendation service 305 can vary the pricing of a given license on a dynamic, per-user basis. The time elapsed since a trial began may also factor into the license pricing. A license may become more or less expensive as a trial period progresses, depending upon which pricing move would optimize revenue.

After having identified which license to recommend to the user, license recommendation service 305 identifies how to surface the recommendation to the user (step 609). The license recommendation may be presented to the user in a variety of ways, such as in a modal dialog that the user has to interact with in order to dismiss it, a modeless notification bar that the user can ignore, or other types of presentations.

License recommendation service 305 eventually arrives at a license recommendation and surfaces it in a user interface to the application under consideration, a user interface to the online application store 301, or in some other user interface (step 611). In some cases, one or more additional license options may be presented to a user. While one of the license may be the recommended one as determined by license recommendation service 305, a second option could be presented to the user for consideration as an alternative.

The user's engagement with the recommendation may be tracked and factored into future recommendations and presentations. For instance, if a premium license has been repeatedly recommended to a user, but repeatedly dismissed by the user, then license recommendation service 305 may conclude not to offer the premium license again. Rather, the recommendation can be changed to a standard recommendation, for instance, that may be more likely to convert the user to a purchase.

Continuing with this example, the user may eventually click on a learn-more button after having being presented with the standard license option. On the next launch of the application, rather than surfacing the premium recommendation again, license recommendation service 305 may surface the standard license recommendation in view of the knowledge that the user demonstrated interest in the standard license.

The following is an operational example discussed in the context of Office 365. The license recommendation system (LRS) in this example utilizes an aggregation of information gathered about the user. This data may be gathered in four main stages.

During the onboarding stage, a user can either purchase Office 365, or get a trial period. In the case of purchasing, regardless of where the user purchases (retail, app stores, Microsoft Store, etc.), when they get the app, they may effectively purchase credit towards an Office subscription rather than any particular stock keeping unit identifier (SKU) of the product. When a user purchases or gets a trial of Office 365, they may need to activate it in the client. On the first run/onboarding experience, users may be asked some basic questions about themselves and their intent for the product. The answers to these questions may be stored. Users may then be able to begin using the product. Some examples of questions which may be asked are: “What devices do you own?” and “What do you intend to use Office for?”

The entry point through which a user gets Office may also be recorded, whether they enter the acquisition flow from a campaign email, online ads, etc.

The second stage relates to the user's natural use of the product. Users may be given a period of time to use the product with all of the features it has to offer. During this time, they may have the chance to explore the features, develop some basic usage patterns and make use of the different benefits available. The usage patterns and benefit uptake may be constantly measured.

This opportunity can also be taken to recommend actions to the user that they may not otherwise try. This would help us to understand not only what the user would discover naturally but also what features are valuable to a user but are not obvious for them to try. This could be done by leveraging messaging options such as emails, teaching UI, templates, in-product messaging, and the like.

This usage data may be gathered for each app on each platform (e.g. Excel on Android phone, Word on iPad, PowerPoint on Office Online). Based on all of this information about the user, once the trial period ends or throughout the trial period, the system may present the user with a dialogue telling them it is time to choose their subscription. In each case, the system may recommend a SKU for the user based on the information it has gathered so far about them. For a user who purchased Office, the system may tell them how long they may get Office for based on the amount of credit they bought at purchase time. For example, if they bought $69.99 worth of credit, they can get either 12 months of Office 365 Personal or 9 months of Office 365 Home.

The third stage pertains to related activities. As well as the time during which the user is allowed to use the product without restrictions, data may also be gathered from other activities taken while the user is signed in. Analysis of the action taken by a user the previous time (or times) a license recommendation was shown may also be performed. This may provide a more complete view of the user, with more nuanced differences and a better overall picture than if the system examined just Office client usage.

The fourth stage involves aggregation across users. Based on renewal data from the previous users, the algorithm that looks at a user's usage and decides on the SKU to recommend may also take into account the actions of other people of the same behavior. For example, if Bob has 1 PC install, 1 iPad install and an Android Phone install, and has also shared his subscription with 2 users who have not used any of the subscription benefits, the system would currently say that he should be recommended Office 365 Home as he has shared his subscription. If the algorithm sees that 90% of the users who have the same usage details as Bob either cancel their subscription or ultimately end up with Personal, it would Offer Bob and anyone else like him Office 365 Personal as it is likely to be the most successful SKU for him. The algorithm can be tuned to optimize for user value, revenue or a balance.

The license recommendation service may be encountered from several entry points. As previously mentioned, it may be invoked at the end of the initial onboarding time to help a user choose an initial SKU. The application may also request recommendations at any time. Several opportunities for use are as follow.

At renewal time, the system can prompt the user with the correct offer for them, to allow them to assess their usage, and to determine whether they want to stay on their current SKU or switch to an alternative. Renewal time may occur at the end of a trial period, at the end of a finite subscription period, or at any other time when a user may consider a new license. For organizations this would only go to the admin. Thus in some implementations, when the developer uploads the available license options, they can annotate that certain license options should only be shown if the user has certain roles defined for them, for example an Administrator role in Microsoft Azure Active Directory.

While there is a set of data points for consumer users, there are additional data points concerning commercial users where the data may be tracked not only at a user level, but also at an organizational level. For example, an application may record various user data points and send these to the license recommendation service via the appropriate API. The following is a list of the sample data points the system may track include.
Number of installations of the app on a particular device
Actions taken that imply intent demonstrated to install on devices
Usage levels of service subscription benefits, such as using a linked service
App usage per app (within the app suite) and per platform (ranging from not installed and installed but unused, to regular user)
Whether an Admin (commercial users) has added users and how many or if the app service supports sharing of consumer licenses, Whether the user has shared their subscription (and with how many guests)
If the service subscription supports multiple members/users, then
Whether the primary user is part of an organization (commercial)
Whether an admin has added team sites
Supplementary content used

The system may group users based on the data gathered from the above points. Each group may have an initial recommended product based on business insights up to this point. Users may move between different groups as they take different actions and use more or less of certain features. Machine learning algorithms may be implemented to improve the recommendations for a particular group of users based on the analysis of the data above for the entire group.

In one implementation, it may be the case that multiple users from within one organization all try the app at the same time. These users may be recognized because a common administrator installed the app for everyone, or because they all share the same email domain name, or through some other mechanism. In this scenario, the usage data is actually pooled across users.

For example, if Bob is put into group 1 based on his usage, we would initially recommend product X to him, based on the system's understanding of customers to date. If the system sees that 75% of users in group 1 do not buy product X, but instead buy product Y, the machine learning algorithm would update to either offer the people of group 1 product X at a discounted rate, or offer them product Y depending on their data. The algorithm would continue to refine product recommendations based on what the user has indicated they want, which aspects of the product the user has used and the previous success rates of the recommendations for the group.

The algorithms may establish patterns from user behaviors to allow the system to predict the correct action for users who have yet to make any choice. The recommendation service may decide which product should be recommended to a user as well as what, if any discounts should be applied for that user.

The algorithm may be aware of whether users are in the same organization and may weigh the usage of others in the organization more heavily when making recommendations to that user. It may also be aware of the type of organization the user is in and may use the behavior of similar organizations to influence the recommendations of each other.

In some implementations, a developer may have different functional levels of their app, each of which provides a greater level of benefits. In the context of an app store, the developer may commonly submit one app together with multiple price points representing each licensing tier. For example, the Accounting app may have three tiers—a personal banking level, one for basic book-keeping for small businesses, while another supports tax reporting/filing capabilities. These could be registered as License1, License2 and License3. Each license may further have one or more upsell messages associated, for example “Buy Contoso Accounting for <price> to stay in control of your finances” or “Save your business money through Contoso tax insights! Buy now for <price>”. These are License1-message1 etc.

Next, the developer may set certain price points per license, for example “$5.99” or “$9.99/month”. In one implementation, the developer may also set elastic price boundaries, for example a top most price of $5.99” for a given license, but also a fallback discounted price point for a given license for users who take a long time/lower price point to be persuaded to buy, for example “$3.99/month”. Other default license recommendations may be submitted (see below after full explanation of the system).

Different descriptive metadata (e.g. app title, app description, app screenshots) may also be submitted per license type, reflecting the particular set of capabilities associated with that particular license.

Finally, the developer submits all the above to the app store developer portal—the app (package) itself, the regular descriptive metadata. AND the license information (license tiers, license messages, license price points). On the app store's storefront, users may see three listings for the app each at a different (non-discounted) price point with the respective descriptions. In another implementation, the app may be just shown as one listing with a way to view each license option.

At this point, the app is available in the Store for users to discover and try. When the user tries the app, it is installed and it runs.

The app when it runs may send data points back to the app store's centralized license recommendation data input service. This may occur when the user has completed an action which may be indicative of a particular license, for example Action 123 of adding a bank account or action 256 of setting their company name, action 982 of their monthly balance being greater than 200,000. This data (in the form of 136 hours after first installation of the app, user 892 takes action 256) is sent to the app store service.

The app may regularly poll the license recommendation service that is run by the app store service to obtain the recommendation for that license. The developer app can design (based on the layout of its own interface) the best graphical presentation for the license. This may include multiple “surfaces” each of which can show the recommended license, for example as a slim-line notification bar whenever the app is launched, or as a more forceful modal pop-up shown towards the end of a 30-day trial. It may also be an email sent to the user by the ISV's service or the App Store service.

At this point, whenever the app is run it may send back data points to the recommendations service and it may periodically poll the app store recommendations service to see if it should show a particular message for a particular license. Optimally, the right license is shown—if it is too expensive, the user may abandon the app. If it is too cheap, potential revenue may be lost.

Note finally that in response to being shown a message, the user may take one of three actions (1) Lack of interest (ignore/dismiss) (2) Partial interest (click on the notification but do not complete purchase) (3) Full interest (complete a purchase). This is the final feed into what recommendations are shown.

The machine learning system (articulated in the section above) determines whether no message is shown or a particular message for a particular license is shown. Multiple implementations of the machine learning system are possible and what is described below is one of many implementations.

The machine learning system, across all users, identifies the correlation between a given action within an app and a particular license purchased (compared to other licenses being purchased). Furthermore, the system re-computes this for the license price point, if multiple price points are possible per license.

Note that in some implementations of the machine learning algorithm, pairs of actions happening within a temporal period may be analyzed (e.g. (1) setting up a cost center and (2) assigned users). For the current user, the system computes license confidence scores, i.e. based on the set of actions the current user has taken, what evidence is there that license 1 should be recommended vs. license 2 and license 3. The system can weigh the recommended license by the price differences between licenses.

For example, if based on user actions alone there is only slightly less weight (0.51) to recommend a $9.99/month license vs. a $4.99/month license (=0.55), the app store can modify the license confidence scores to incorporate revenue potential, so now the final set of license confidence scores would recommend the more expensive license (=0.63) over the cheaper license (=0.58)

This way of weighting value for the user (just rely on app actions) vs. revenue (bias the recommendations based on revenue) may also be set by the developer at submission time.

If discounting pricing is available, the same calculations as above may be performed to compute a given price point for a given license. In this case, the calculation may be to compute the likelihood for the user to purchase the app at all at the higher price point versus the likelihood for the user to purchase the app at all for the lower price point. High price points may be preferred at the start of the trial, while lower discounts are chosen closer to trial end.

Across all users, for a given elapsed time (e.g. 3 days since the app trial began), the system identifies the correlation between showing a user particular message for a particular license with a particular price, and the likelihood of them actually purchasing. This computation could include the history of what notifications were previously shown to that user, e.g. did they see license 1 on day 2 but ignore it?

Optionally, the computation may include further correlation between showing a user a given license/price point and a user actually abandoning the app altogether (i.e. a high price point scares them off). This abandonment score may be subtracted from particular recommended license+price point scores.

Finally, the learning system may also calculate the optimum “time to learn license preferences based on user action”. In one implementation, this might be: Which user actions were the most statistically significantly correlated with non-basic license purchases? What is the typical (80th percentile) time taken within a trial for a user to take these actions? Note that the number 80 may itself be modified based on revenue earned over time.

The calculation of this number determines how many days to wait before showing the first license recommendations. Alternately, a more complex system may be developed that computes the typical % of non-basic license user actions taken by a given day after the trial commencement. This could act as a threshold for showing a given license recommendation. This would mean that if a user did take a particular action that had very strong weight for a non-basic license very early in the trial, the recommendation would be shown much earlier providing it exceeded the chosen threshold.

Finally, the message suppression system needs to be moderated by the trial length. Any system that waits until day 30 of a 30-day trial to start upselling may not give the user sufficient time to purchase—so the proximity to trial end should reduce the required threshold for showing a message.

At this point, the system has developed the following. The user acquires the app from the store and launches it to start their trial. The user completes certain actions within the app—which are sent back to the app store. These actions before day 4 do not show particularly strong evidence for a given license. Additionally, purchases of non-basic licenses for this app happen most often for users showing actions 673 and 891 which are rarely completed before day 4. On day 4, the user again launches the app. The user has by now taken certain actions within the app. Based on analysis of all other users of the app, license 2 is recommended, and message 1 at price point 1 is recommended. The weight of this recommendation meets the required threshold, so is returned to the app by the app store service

The app now shows the user a notification within the app to “Buy Small Business Accounting to keep your business ticking over for just $9.99/month”. They happen to ignore the notification. This data point for this user is sent back to the app store service.

They ignore further notifications and on day 23, they are again using the app. This time, given their increased proximity to trial end, the recommendation for a discounted price for license 2 has greater score than the recommendation for a non-discounted price. The user sees the new discounted message and completes the purchase. This data point for this user is sent back to the app store service.

The developer in their dashboard may see purchase results for each license/price point/message, and they may update each of these. The developer may finally have further controls to suggest defaults. For example, they may submit user actions they feel are always indicative of preference for a certain license. In such cases, if ever the user takes a particular action, the app store license recommendations service may always suggest the license.

They may also submit user actions they feel are sometimes indicative of preference for a certain license. In such cases, the numbers form the initial seeding of the license recommendations service. However, their weight (as a factor in recommendations) decreased as real usage data supersedes the best guess by the developer.

They may also submit default messages/preferred messages. In such cases, the numbers form the initial seeding of the license recommendations service. However, their weight (as a factor in recommendations) decreased as real usage data supersedes the best guess by the developer.

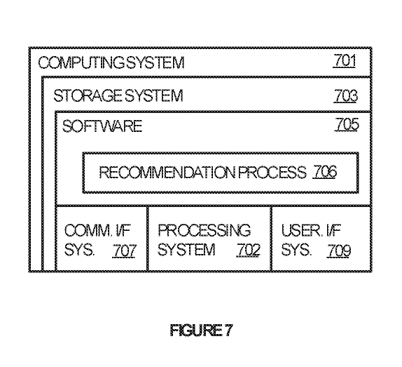

FIG. 7 illustrates computing system 701, which is representative of any system or collection of systems in which the various applications, services, scenarios, and processes disclosed herein may be implemented. Examples of computing system 701 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes recommendation process 706 which is representative of the processes discussed with respect to the preceding FIGS. 1-6, including recommendation process 200, 400, and 600. When executed by processing system 702 to enhance licensing recommendations, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions for implementing a license recommendation service (e.g. 105 and 305).

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtual machine software, or other application software, in addition to or that include recommendation process 706. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to enhance licensing operations. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here.

User interface system 709 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

### Example 1

A method of operating an online app store comprising an application service and a license recommendation service, the method comprising: in the application service, downloading an instance of an application to a local execution environment to be installed and run under an initial license; in the license recommendation service, receiving usage information from the instance of the application indicative of actual usage of the instance of the application under the initial license; in the license recommendation service, identifying which license from a set of potential licenses for the application to recommend to a user based at least in part on the usage information and communicating a license recommendation to the application service that identifies the license; and in the application service, communicating the license recommendation to the local execution environment for consideration by the user.

### Example 2

The method of Example 1 further comprising, in the license recommendation service, receiving usage criteria for each of the potential licenses from a developer platform associated with the application.

### Example 3

The method of Examples 1-2 wherein identifying the license to recommend to the user based at least in part on the usage information comprises comparing the actual usage to the usage criteria for each of the potential licenses.

### Example 4

The method of Examples 1-3 further comprising the license recommendation service receiving other usage information from other instances of the application indicative of other actual usage of the other instances of the application wider one or more of the potential licenses.

### Example 5

The method of Examples 1-4 wherein identifying the license to recommend to the user based at least in part on the usage information comprises comparing the actual usage to the usage criteria for each of the potential licenses.

### Example 6

The method of Examples 1-5 further comprises the license recommendation service generating modifications to the usage criteria based on the other usage information.

### Example 7

The method of Examples 1-6 further comprising the license recommendation service communicating with the developer platform to obtain authorization for the modifications.

### Example 8

The method of Examples 1-7 wherein communicating the license recommendation to the local execution environment for consideration by the user comprises surfacing the license recommendation in a webpage comprising a storefront interface to the online app store.

### Example 9

The method of Examples 1-8 wherein communicating the license recommendation to the local execution environment for consideration by the user comprises surfacing the license recommendation in a user interface to the instance of the application.

### Example 10

A computing apparatus comprising: one or more computer readable storage media; a processing system operatively coupled with the one or more compute readable storage media; and an instance of an application stored on the one or more computer readable storage media and comprising program instructions that, when executed by the processing system, direct the processing system to at least: monitor actual usage of the instance of the application over a period of time between occurrences of a plurality of key events; monitor for the plurality of key events to occur in the instance of the application; in response to a one of the key events occurring, identifying the actual usage of the instance of the application during the period of time between the one of the key events and a previous one of the key events; and communicating the actual usage to a license recommendation service in an online app store from wherein the instance of the application was downloaded.

### Example 11

The computing apparatus of Example 10 wherein the program instructions further direct the processing system to, in response to receiving a license recommendation from the license recommendation service, surface the license recommendation in the user interface.

### Example 12

A computing apparatus comprising one or more computer readable storage media; one or more processing systems; an online app store service stored on the one or more computer readable storage media and comprising program instructions that, when executed by the one or more processing systems, direct the one or more processing systems to at least: download an instance of an application to a local execution environment to be installed and run under an initial license; receive usage information from the instance of the application indicative of actual usage of the instance of the application under the initial license; identify which license from a set of potential licenses for the application to recommend to a user based at least in part on the usage information; and communicate a license recommendation the local execution environment that identifies the license.

### Example 13

The computing apparatus of Example 12 wherein the program instructions further direct the one or more processing systems to receive usage criteria for each of the potential licenses from a developer platform associated with the application.

### Example 14

The computing apparatus of Examples 12-13 wherein to identify the license to recommend to the user based at least in part on the usage information, the program instructions further direct the one or more processing systems to compare the actual usage to the usage criteria for each of the potential licenses.

### Example 15

The computing apparatus of Examples 12-14 wherein the program instructions further direct the one or more processing systems to receive other usage information from other instances of the application indicative of other actual usage of the other instances of the application under one or more of the potential licenses.

### Example 16

The computing apparatus of Examples 12-15 wherein to identify the license to recommend to the user based at least in part on the usage information, the program instructions further direct the one or more processing systems to compare the actual usage to the usage criteria for each of the potential licenses.

### Example 17

The computing apparatus of Examples 12-16 wherein the program instructions further direct the one or more processing systems to generate modifications to the usage criteria based on the other usage information.

### Example 18

The computing apparatus of Examples 12-17 wherein the program instructions further direct the one or more processing systems to communicate with the developer platform to obtain authorization for the modifications.

### Example 19

The computing apparatus of Examples 12-18 wherein to communicate the license recommendation to the local execution environment for consideration by the user, the program instructions direct the one or more processing systems to surface the license recommendation in a webpage comprising a storefront interface to the online app store service.

### Example 20

The computing apparatus of Examples 12-19 wherein to communicate the license recommendation to the local execution environment for consideration by the user, the program instructions direct the one or more processing systems to surface the license recommendation in a user interface to the instance of the application.

The functional block diagrams, operational scenarios and sequences, and flow diagrams provided in the Figures are representative of exemplary systems, enviromnents, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of operating an online app store comprising an application service and a license recommendation service, the method comprising:
in the application service, downloading an instance of an application to a local execution environment to be installed and run under an initial license;
in the license recommendation service, receiving usage information from the instance of the application indicative of actual usage of the instance of the application under the initial license;
in the license recommendation service, identifying which license from a set of potential licenses for the application to recommend to a user based at least in part on the usage information and communicating a license recommendation to the application service that identifies the license; and
in the application service, communicating the license recommendation to the local execution environment for consideration by the user.

2. The method of claim 1 further comprising, in the license recommendation service, receiving usage criteria for each of the potential licenses from a developer platform associated with the application.

3. The method of claim 2 wherein identifying the license to recommend to the user based at least in part on the usage information comprises comparing the actual usage to the usage criteria for each of the potential licenses.

4. The method of claim 3 further comprising the license recommendation service receiving other usage information from other instances of the application indicative of other actual usage of the other instances of the application under one or more of the potential licenses.

5. The method of claim 4 wherein identifying the license to recommend to the user based at least in part on the usage information comprises comparing the actual usage to the usage criteria for each of the potential licenses.

6. The method of claim 5 further comprises the license recommendation service generating modifications to the usage criteria based on the other usage information.

7. The method of claim 1 further comprising surfacing a message in a user interface to the application that includes the license recommendation and that varies over time as a time period for the initial license progresses.

8. The method of claim 1 wherein communicating the license recommendation to the local execution environment for consideration by the user comprises surfacing the license recommendation in a webpage comprising a storefront interface to the online app store.

9. The method of claim 1 wherein communicating the license recommendation to the local execution environment for consideration by the user comprises surfacing the license recommendation in a user interface to the instance of the application.

10. A computing apparatus comprising:
one or more computer readable storage media;
a processing system operatively coupled with the one or more compute readable storage media; and
an instance of an application stored on the one or more computer readable storage media and comprising program instructions that, when executed by the processing system, direct the processing system to at least:
monitor actual usage of the instance of the application over a period of time between occurrences of a plurality of key events;
monitor for the plurality of key events to occur in the instance of the application;
in response to a one of the key events occurring, identifying the actual usage of the instance of the application during the period of time between the one of the key events and a previous one of the key events; and
communicating the actual usage to a license recommendation service in an online app store from wherein the instance of the application was downloaded.

11. The computing apparatus of claim 10 wherein the program instructions further direct the processing system to, in response to receiving a license recommendation from the license recommendation service, surface the license recommendation in the user interface.

12. A computing apparatus comprising
one or more computer readable storage media;
one or more processing systems;
an online app store service stored on the one or more computer readable storage media and comprising program instructions that, when executed by the one or more processing systems, direct the one or more processing systems to at least:
download an instance of an application to a local execution environment to be installed and run under an initial license;
receive usage information from the instance of the application indicative of actual usage of the instance of the application under the initial license;
identify which license from a set of potential licenses for the application to recommend to a user based at least in part on the usage information; and
communicate a license recommendation the local execution environment that identifies the license.

13. The computing apparatus of claim 12 wherein the program instructions further direct the one or more processing systems to receive usage criteria for each of the potential licenses from a developer platform associated with the application.

14. The computing apparatus of claim 13 wherein to identify the license to recommend to the user based at least in part on the usage information, the program instructions further direct the one or more processing systems to compare the actual usage to the usage criteria for each of the potential licenses.

15. The computing apparatus of claim 14 wherein the program instructions further direct the one or more processing systems to receive other usage information from other instances of the application indicative of other actual usage of the other instances of the application under one or more of the potential licenses.

16. The computing apparatus of claim 15 wherein to identify the license to recommend to the user based at least in part on the usage information, the program instructions further direct the one or more processing systems to compare the actual usage to the usage criteria for each of the potential licenses.

17. The computing apparatus of claim 16 wherein the program instructions further direct the one or more processing systems to generate modifications to the usage criteria based on the other usage information.

18. The computing apparatus of claim 17 wherein the program instructions further direct the one or more processing systems to communicate with the developer platform to obtain authorization for the modifications.

19. The computing apparatus of claim 12 wherein to communicate the license recommendation to the local execution environment for consideration by the user, the program instructions direct the one or more processing systems to surface the license recommendation in a webpage comprising a storefront interface to the online app store service.

20. The computing apparatus of claim 12 wherein to communicate the license recommendation to the local execution environment for consideration by the user, the program instructions direct the one or more processing systems to surface the license recommendation in a user interface to the instance of the application.
